(19) United States
(12) Patent Application Publication
(10) Pub. No.: US 2013/0124409 A1
(43) Pub. Date: May 16, 2013

(54) RELOADABLE PREPAID PLATFORM

(71) Applicants: Jeffrey Norman Healy, Matthews, NC (US); Kimberly Belle Summerrow, Charlotte, NC (US); Craig Allan Hall, Albuquerque, NM (US)

(72) Inventors: Jeffrey Norman Healy, Matthews, NC (US); Kimberly Belle Summerrow, Charlotte, NC (US); Craig Allan Hall, Albuquerque, NM (US)

(73) Assignee: Bank of America Corporation, Charlotte, NC (US)

(21) Appl. No.: 13/293,952

(22) Filed: Nov. 10, 2011

(51) Int. Cl. G06Q 40/02

(52) U.S. Cl. 705/43

(57) ABSTRACT

A reloadable prepaid platform configured to permit reloading of a general purpose prepaid card at an automated teller machine (ATM) is disclosed. Particularly, the prepaid platform interacts with an ATM of the financial institution associated with the prepaid card in order to receive funds from the user at the ATM and reload the prepaid card. The reload may generally be a cash reload; however, check reloads as well as transfer reloads from other accounts are contemplated herein.

### BACKGROUND

In today's “digital age,” more and more processes are becoming digital or automated. This is especially true in the financial industry. Over the years, primary methods for payment have evolved from cash to checks to credit and debit cards. More recently, prepaid cards have become widely available to consumers.

Prepaid cards may be of different varieties. For instance, some prepaid cards are issued in association with particular merchants. Such cards can be used only when purchasing goods or services from a particular merchant, similar to the limited usage associated with store credit cards. These types of prepaid cards are generally not reloadable, and the card is discarded after the funds loaded have been exhausted. Non-reloadable merchant-specific prepaid cards may be referred to as gift cards.

Another type of prepaid card is a general purpose prepaid card. General purpose prepaid cards may be used by consumers at a variety of retailers accepting payment cards issued and/or authorized by a payment brand. The most prominent payment brands include Visa®, MasterCard®, American Express®, and Discover®. General purpose prepaid cards may be non-reloadable or reloadable.

General purpose prepaid cards are becoming more common as the percentage of transactions continue to gravitate away from cash/check transactions to electronic transactions. Many consumers that utilize prepaid cards versus debit/credit cards do so to take advantage of the benefits of electronic transactions, but do not have established bank or credit card accounts (e.g., unbanked/under-banked consumers).

A problem associated with reloadable prepaid cards is that the process for reloading may be extraordinarily inconvenient in that reloading stations are generally not readily available. For example, currently there are no prepaid cards associated with a particular financial institution that may be reloaded at an automated teller machine (ATM). Additionally, internet reloading may be problematic for consumers that wish to cash load a prepaid card or do not have an account at a financial institution from which to transfer funds electronically to the prepaid card.

Thus, a need presently exists for a reloadable prepaid platform that may be utilized to reload general purpose prepaid cards at an ATM of a financial institution associated with the card.

### SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Embodiments of the present invention address the above needs and/or achieve other advantages by providing an apparatus (e.g., a system, computer program product, and/or other device), method, or a combination of the foregoing for a reloadable prepaid platform configured to permit ATM reloading of general purpose prepaid cards associated with a financial institution.

In one aspect of the invention, a method for reloading a general purpose prepaid card at an ATM is provided. The method includes authenticating a user of the general purpose prepaid card at the ATM. The prepaid card is associated with a financial institution; generally the financial institution which operates the ATM. The method further includes receiving, at the ATM, funds from the user. Finally, the method additionally includes reloading the general purpose prepaid card. In some embodiments of the method, the funds received at the ATM are immediately reloaded to the prepaid card.

In some embodiments, the method further includes communicating with a reloadable prepaid platform. In some such embodiments, the reloadable prepaid platform is administered by a third-party. The third-party may be additionally associated with one or more financial institutions other than the financial institution associated with the prepaid card. In some such embodiments, the prepaid card may be reloaded at an ATM of at least one of the one or more financial institutions other than the financial institution associated with the prepaid card.

In some embodiments of the method, the funds received are cash only. In other embodiments, the funds received may include checks.

In some embodiments of the method, the ATM is configured to reload the prepaid card irrespective of any other association, including financial accounts, between the user and the financial institution. Thus, the user's only association with the financial institution may simply be the prepaid card associated with the financial institution. In a particular embodiment, the reloadable prepaid card is a consumer prepaid card (e.g., non-commercial).

In some embodiments of the method, the prepaid card is a magnetic stripe card. In some embodiments, the prepaid card is a physical card and is configured for wireless communication. In some embodiments, the prepaid card is embodied in a mobile wallet of a mobile device of the user. In some embodiments of the method, the ATM includes a contactless interface. The contactless interface may be utilized to communicate wirelessly with the prepaid card.

In another aspect of the invention, a system for reloading a general purpose prepaid card at an ATM is provided. The system includes an ATM that includes a processing device configured for authenticating a user of the general purpose prepaid card at the ATM. The prepaid card is associated with a financial institution; generally the financial institution which operates the ATM. The processing device may be additionally configured for receiving, at the ATM, funds from the user. Furthermore, the processing device may additionally be configured for reloading the general purpose prepaid card. The system may further include a financial network in communication with the ATM. Finally, the system may additionally include a reloadable prepaid platform in communication with the financial network.

In some embodiments of the system, the reloadable prepaid platform is administered by a third-party. The third-party may be additionally associated with one or more financial institutions other than the financial institution associated with the prepaid card. In some such embodiments, the system may further include a second ATM of one of the one or more financial institutions other than the financial institution associated with the prepaid card. In such embodiments, the prepaid card may additionally be reloaded at the second ATM.

In some embodiments of the system, the funds received are cash only. In other embodiments, the funds received may include checks.

In some embodiments of the system, the processing device is configured to reload the prepaid card irrespective of any other association, including financial accounts, between the user and the financial institution. Thus, the user's only association with the financial institution may simply be the prepaid card associated with the financial institution. In a particular embodiment, the reloadable prepaid card is a consumer prepaid card (e.g., non-commercial).

In some embodiments of the system, the prepaid card is a physical card and is configured for wireless communication. In some embodiments, the prepaid card is embodied in a mobile wallet of a mobile device of the user. In some embodiments of the system, the ATM includes a contactless interface. The contactless interface may be utilized to communicate wirelessly with the prepaid card.

In another aspect of the invention, a computer program product for reloading a general purpose prepaid card at an ATM is provided. The computer program produce includes a non-transitory computer readable medium that includes computer-readable instructions. The instructions include instructions for authenticating a user of the general purpose prepaid card at the ATM. The prepaid card is associated with a financial institution; generally the financial institution which operates the ATM. The instructions further include instructions for receiving, at the ATM, funds from the user. Additionally, the instructions include instructions for reloading the general purpose prepaid card. In some embodiments of the computer program product, the instructions include instructions for immediately reloading the prepaid card upon receipt of the funds at the ATM.

In some embodiments of the computer program product, the instructions further include instructions for communicating with a reloadable prepaid platform. In some such embodiments, the reloadable prepaid platform may be administered by a third-party. The third-party may be additionally associated with one or more financial institutions other than the financial institution associated with the prepaid card. In some such embodiments, the instructions may further include instructions for reloading the prepaid card at an ATM of at least one of the one or more financial institutions other than the financial institution associated with the prepaid card.

In some embodiments of the computer program product, the funds received are cash only. In other embodiments, the funds received may include checks.

In some embodiments of the computer program product, the instructions include instructions for reloading the prepaid card irrespective of any other association, including financial accounts, between the user and the financial institution. Thus, the user's only association with the financial institution may simply be the prepaid card associated with the financial institution. In a particular embodiment, the reloadable prepaid card is a consumer prepaid card (e.g., non-commercial).

In some embodiments of the computer program product, the prepaid card is a physical card and is configured for wireless communication. In some embodiments, the prepaid card is embodied in a mobile wallet of a mobile device of the user. In some embodiments of the computer program product, the ATM includes a contactless interface. The contactless interface may be utilized to communicate wirelessly with the prepaid card.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIGS. 1A and 1B illustrate an example embodiment of a prepaid card, in accordance with an embodiment of the invention;

FIG. 2 illustrates a block diagram of a reloadable prepaid system, in accordance with an embodiment of the invention;

FIGS. 3A-3F illustrate example ATM user interface screens, in accordance with an embodiment of the invention;

FIG. 4 is a flow diagram of a method for reloading a prepaid card at an ATM, in accordance with an embodiment of the invention;

FIG. 5 illustrates a block diagram illustrating a contactless transaction environment, in accordance with an embodiment of the invention;

FIG. 6 illustrates a block diagram illustrating an ATM, in accordance with an embodiment of the invention;

FIG. 7 illustrates a block diagram illustrating a contactless interface, in accordance with an embodiment of the invention;

FIG. 8A illustrates a block diagram illustrating an external apparatus such as a debit/credit card or a sticker equipped for one-way data transmission to the ATM;

FIG. 8B illustrates a block diagram illustrating an external apparatus such as a debit/credit card or a sticker that is equipped for two-way data transmission to and from the ATM;

FIG. 9 illustrates a block diagram illustrating a mobile device, in accordance with an embodiment of the invention;

FIG. 10 is a flow diagram of a method for receiving a contactless transmission from the external apparatus to the ATM; and

FIG. 11 is a mixed block and flow diagram of a method for contactless transmission from an external apparatus to an ATM, in accordance with an embodiment of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

In accordance with embodiments of the invention, the term “financial institution” refers to any organization in the business of moving, investing, or lending money, dealing in financial instruments, or providing financial services. This includes commercial banks, thrifts, federal and state savings banks, savings and loan associations, credit unions, investment companies, insurance companies and the like.

In general, embodiments of the present invention relate to apparatuses, methods and computer program products for a reloadable prepaid platform capable of reloading prepaid cards at an ATM associated with the financial institution. Particularly, the prepaid platform interacts with an ATM of the financial institution associated with the prepaid card in order to receive funds from the user at the ATM and reload the prepaid card. The reload may generally be a cash reload; however, check reloads as well as transfer reloads from other accounts are contemplated herein.

As indicated above, the prepaid card industry is rapidly growing. With the increase in electronic payments, more and more users are opting to utilize prepaid cards rather than debit or credit cards. This is especially true for consumers that are unbanked or under-banked for reasons such as bad credit such that they cannot obtain a credit card, cannot pay fees associated with maintaining an account at a financial institution, etc.

Furthermore, in light of recent legislation in The Restoring American Financial Stability Act of 2010, and specifically the Durbin Amendment to the Act, it is expected that financial institutions will be forced to recover revenue losses from decreased fees received from merchants by increasing fees to the customer for maintaining the account, reducing incentive programs to the customers, etc. However, while the capped fees receivable from merchants under the Durbin Amendment applies to debit card transactions, credit card transactions, non-reloadable prepaid cards, other gift cards, etc., the Amendment specifically exempts reloadable general purpose prepaid cards. As such, a financial institution may be able to offer customers a reloadable prepaid card means for electronic payment transmission with fees lower than a traditional checking/savings account as the financial institution would be permitted to receive more revenue from the merchant.

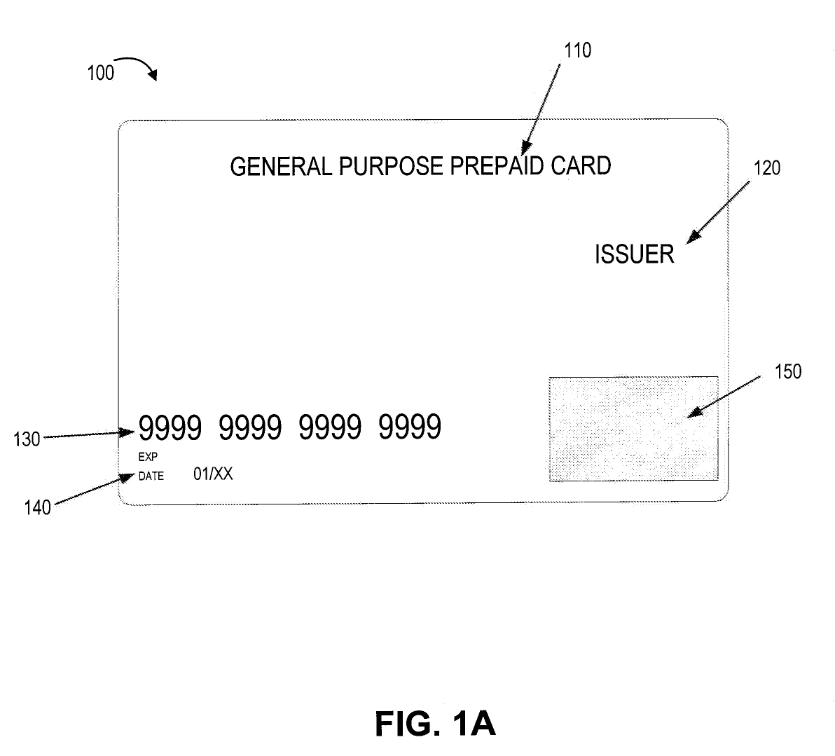

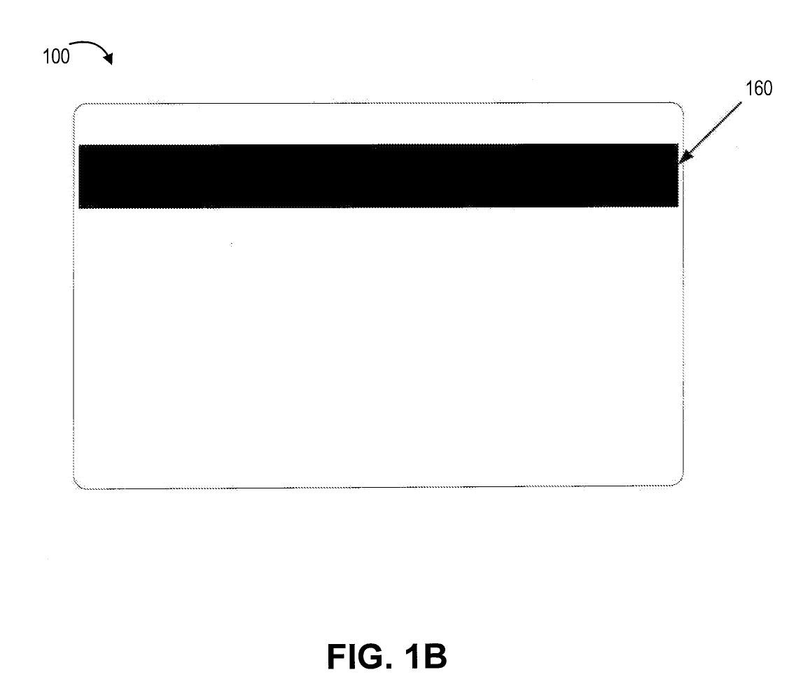

FIGS. 1A and 1B illustrate a general purpose prepaid card 100. The card 100 looks similar to a conventional magnetic stripe card and includes magnetic stripe 160 on the back (FIG. 1B). The front side (FIG. 1A) of the card 100 preferably identifies the card with an identifying title 110 which may identify the card as a “General Purpose Prepaid Card.” The front of the card may additionally include the financial institution issuer's name 120, the prepaid card 100's unique identifying number 130 and, in some cases, an expiration date 140. The card 100 also includes the payment brand 150 (e.g., Visa®).

It should be noted that FIGS. 1A and 1B illustrate only one embodiment of the general purpose prepaid card 100 of the present invention. The card 100 may include less features (such as no expiration date 140) or more features such as internal circuitry (memory, microprocessor, wireless communication device, etc.) giving the card 100 smart card functionality.

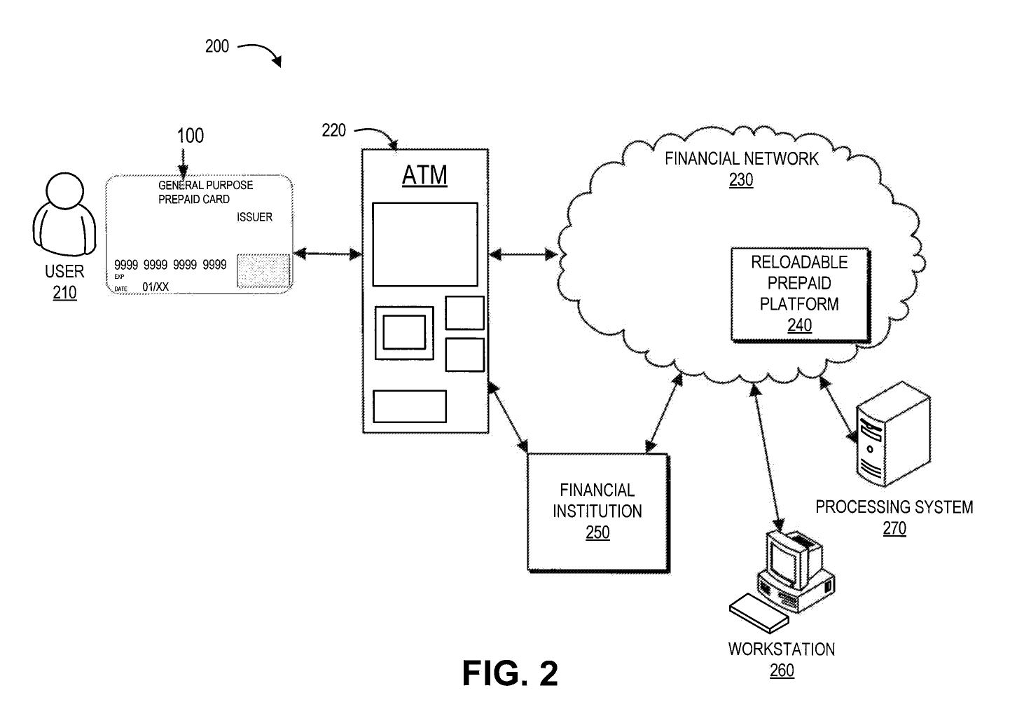

Referring to FIG. 2, a block diagram illustrating a reloadable prepaid system 200 is shown. As illustrated, the reloadable prepaid system 200 includes a general purpose prepaid card 100 belonging to a user 210 who is a customer of the financial institution who wishes to reload the prepaid card 100 via an ATM 220 associated with the financial institution. In most embodiments, the general purpose card of the invention is associated with a specific financial institution and is only reloadable at ATMs 220 associated with the specific financial institution. Of course, other means of reloading not involving an ATM are also contemplated herein.

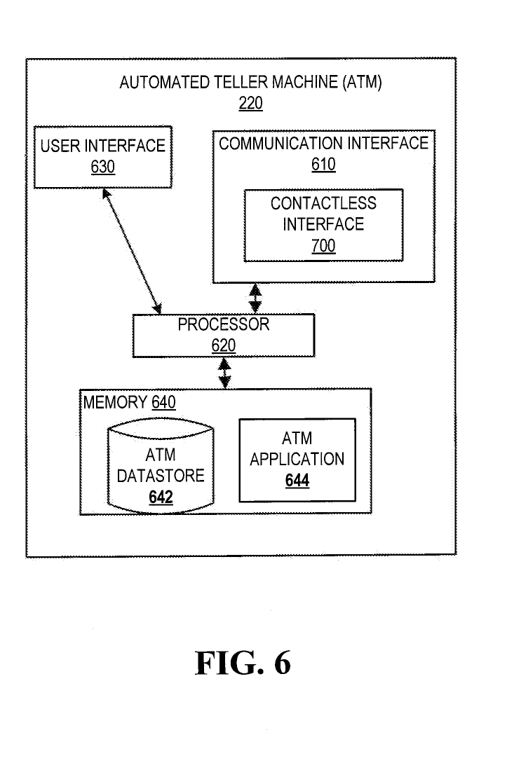

The ATM 220 may be any typical ATM 220 that has been specially equipped with an application capable of interacting with the specialized reloadable prepaid platform 240 via the financial network 230. Various functionality and features of suitable ATMs is described in more detail below with respect to FIG. 6.

The reloadable prepaid platform 240 is configured to interact with the ATM 220 and user 210 in order to receive a cash load from the user 210 via the ATM 220 and reload the user's prepaid card 100. In one embodiment, the reloadable prepaid platform 240 is operated and administered by a third party. As noted above, in most embodiments, the platform 240 is only capable of interacting with ATMs 220 of the financial institution that the reloadable prepaid card 100 is associated with. However, it is contemplated herein that the third party administrator of the reloadable prepaid platform 240 may be associated with other financial institutions such that other financial institution's ATMs may be configured to interact with the specialized reloadable prepaid platform 240. With such an arrangement, a foreign ATM 220, i.e., an ATM not associated with the financial institution associated with the user's prepaid card 100, may accept a cash load and reload the user's prepaid card 100. In such situations, it is contemplated that additional fees may apply.

While the invention is described generally herein as “cash” reloading of a prepaid card 100 via an ATM 220, it is contemplated herein that the prepaid card 100 may be reloaded utilizing a check reload, funds transfer, or any other means to add funds to the prepaid card 100. However, in some circumstances, the reloaded funds may not be made readily available to the user 210 as alternate reloading means (i.e., other than cash) may require additional processing/clearing time.

In FIG. 2, the financial network 230 may include a local area network (LAN), a wide area network (WAN), and/or a global area network (GAN). The financial network 230 may provide for wireline, wireless, or a combination of wireline and wireless communication between devices in communication with the network 230. In some embodiments, the financial network 230 includes the Internet. In some embodiments, the network 230 may include a wireless telephone network.

As illustrated, the ATM 220 may be connected to a workstation 260 via the financial network 230. The workstation 260 may be used by a third party/entity to interact with the ATM 220. The third party/entity may include, for example, an administrator of the reloadable prepaid platform 240. The workstation 260 may include various features, such as a network communication interface, a processing device, a user interface, and a memory device.

As used with respect to the workstation 260, a “communication interface” may generally include a modem, server, transceiver, and/or other device for communicating with other devices on a network. The network communication interface may be a communication interface having one or more communication devices configured to communicate with one or more other devices on the financial network 230, such as the ATM 220, the processing system 270, other processing systems, data systems, etc.

Additionally, referring to the workstation 260, a “processing device” may generally refer to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device may be configured to use the network communication interface to transmit and/or receive data and/or commands to and/or from the other devices connected to the network 230.

Furthermore, a “user interface” within the workstation 260 may generally include a plurality of interface devices and/or software that allow a user to input commands and data to direct the processing device to execute instructions. For example, the user interface may include a graphical user interface (GUI) or an interface to input computer-executable instructions that direct the processing device to carry out specific functions. The user interface may employ certain input and output devices to input data received from the user or output data to the user. These input and output devices may include a display, mouse, keyboard, button, touchpad, touch screen, microphone, speaker, light, joystick, switch, and/or other customer input/output device for communicating with one or more customers.

A “memory device” within the workstation 260 may generally refer to a device or combination of devices that store one or more forms of computer-readable media for storing data and/or computer-executable program code/instructions. For example, the memory device may include any computer memory that provides an actual or virtual space to temporarily or permanently store data and/or commands provided to the processing device when it carries out its functions described herein.

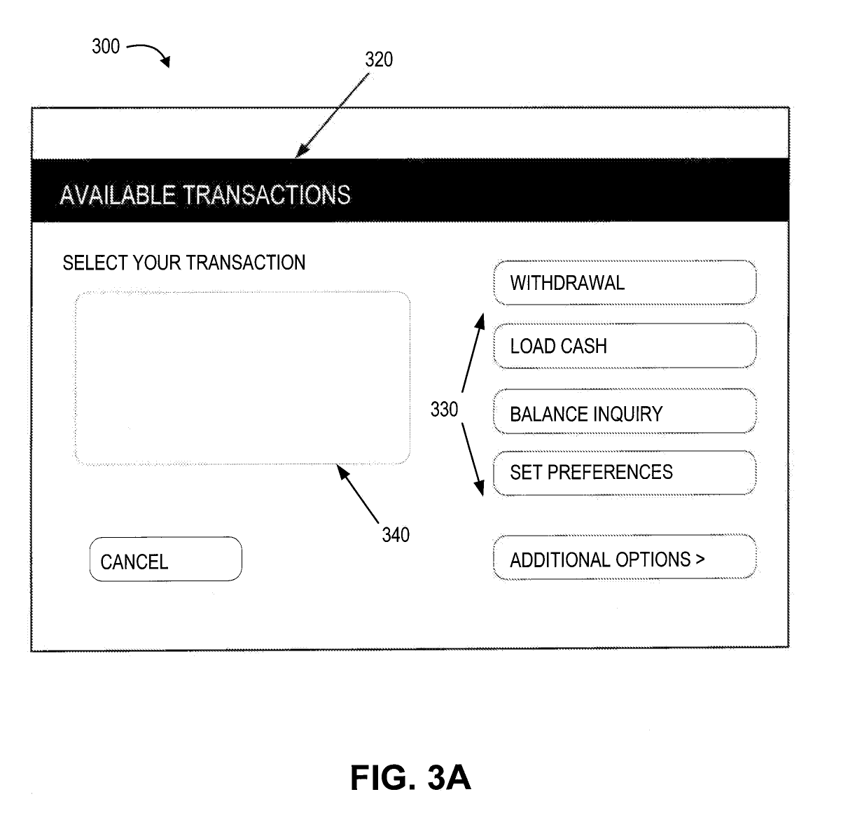

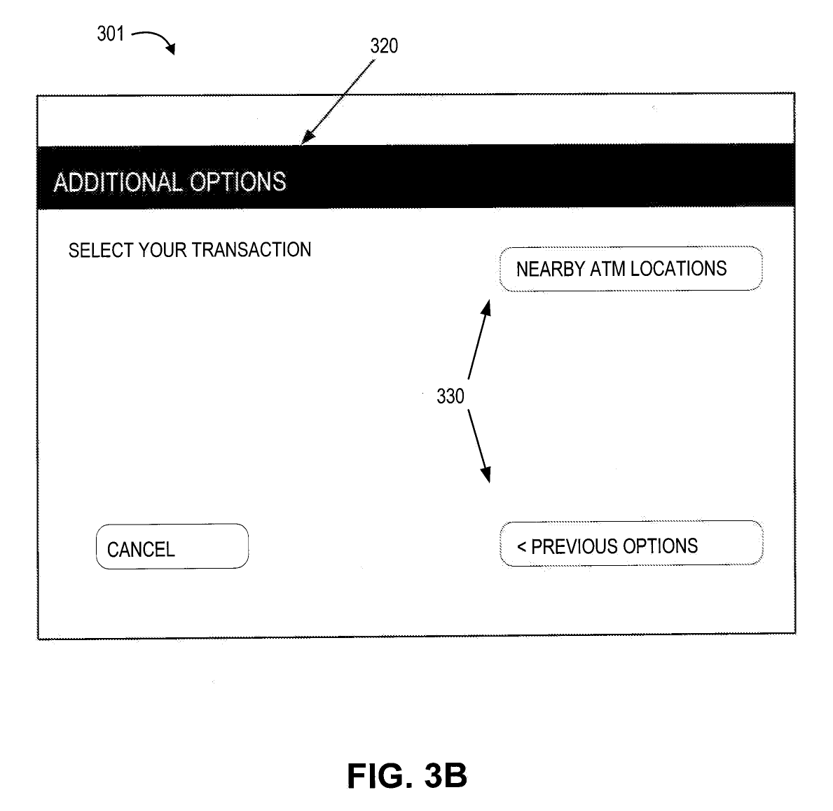

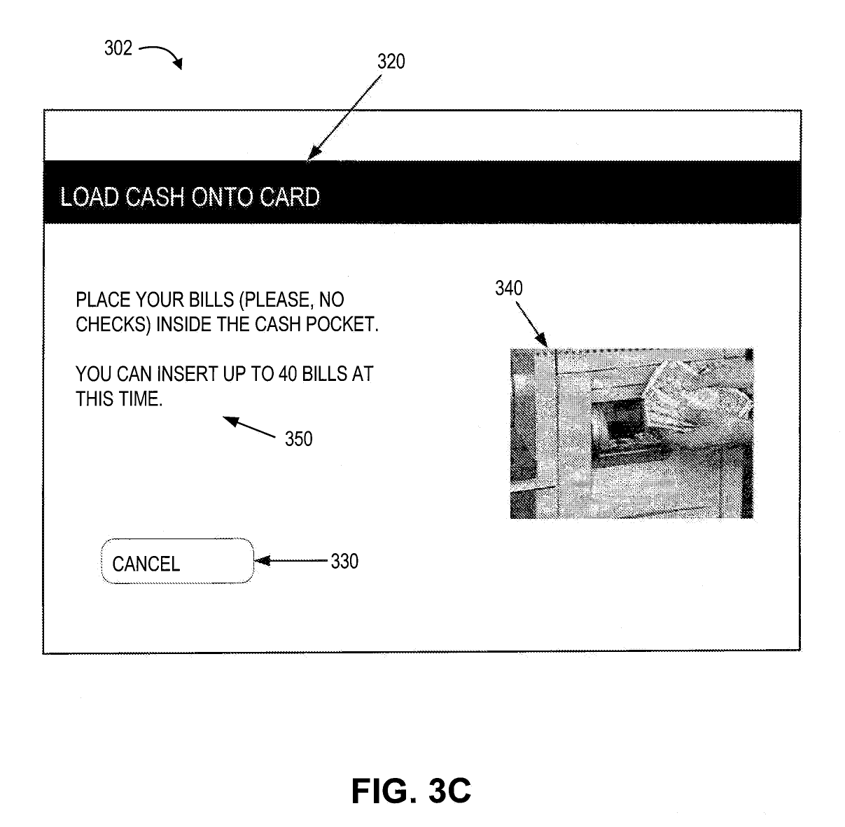

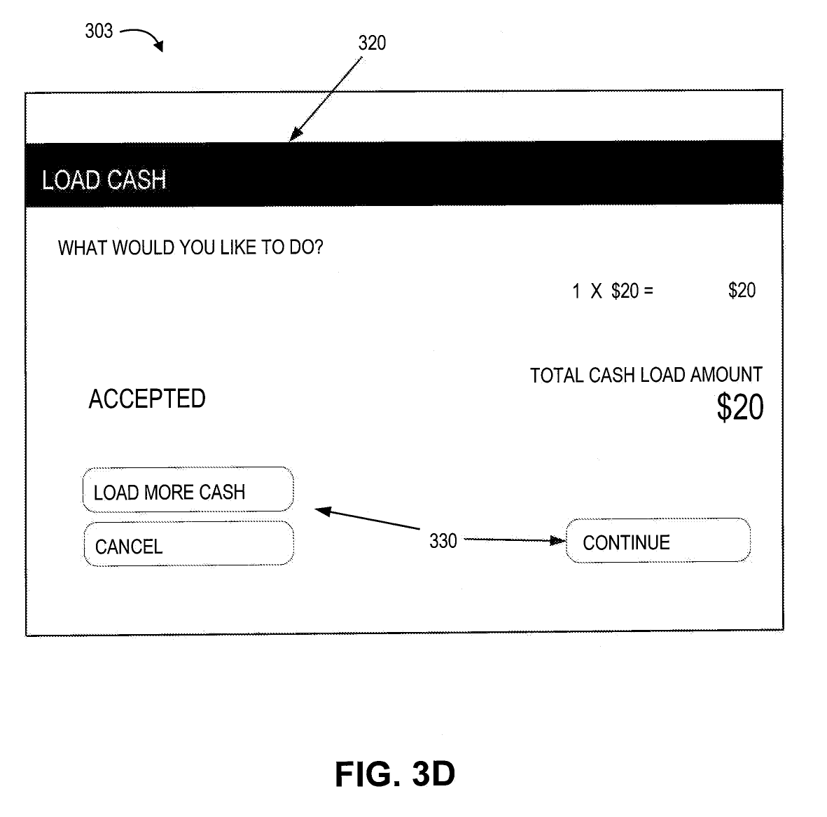

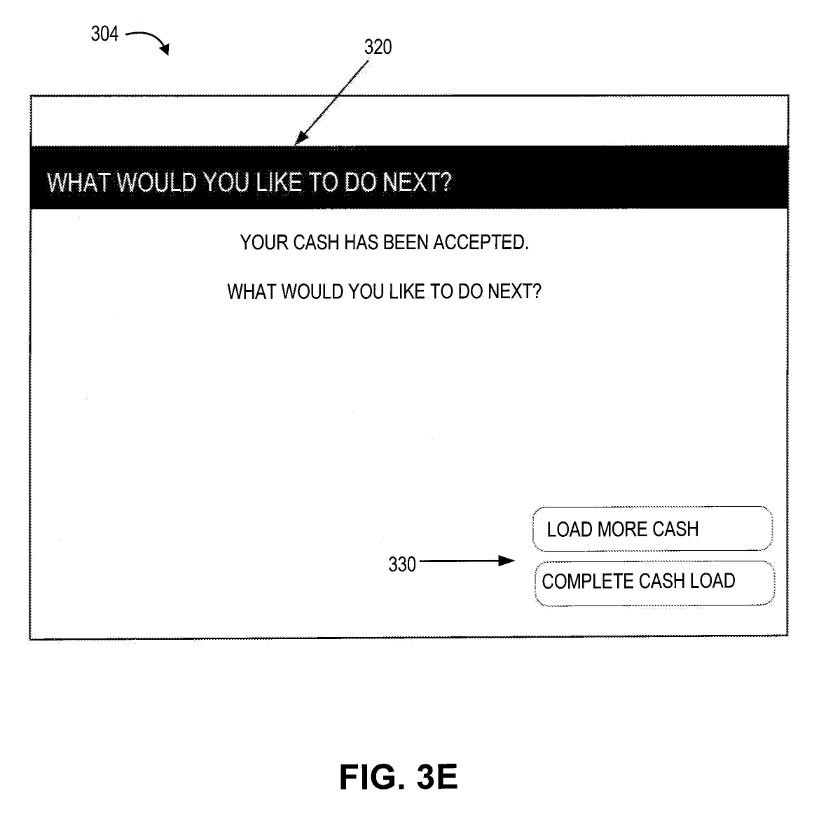

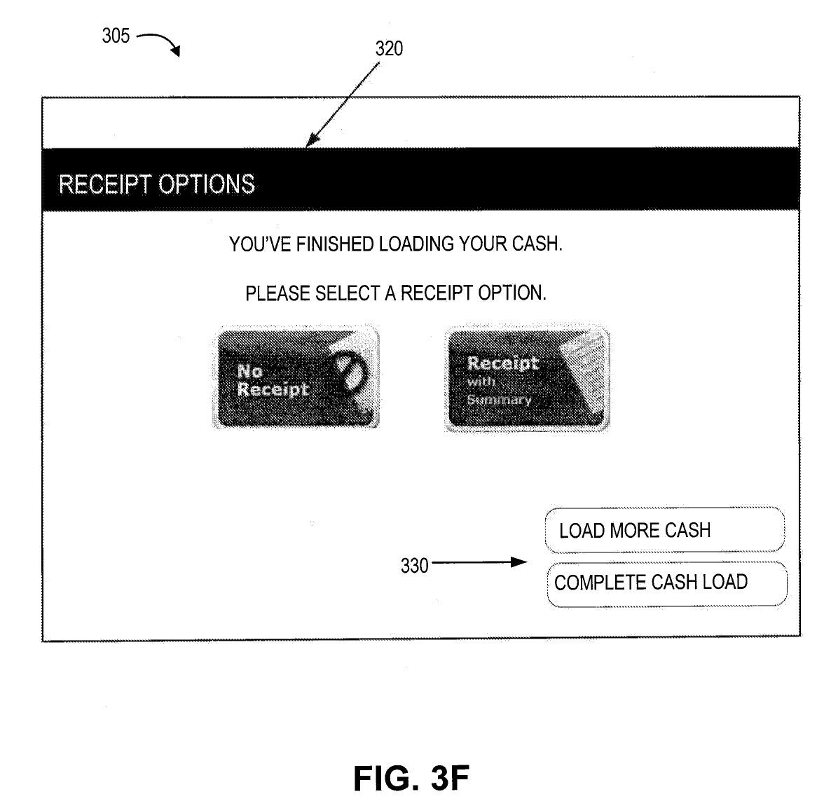

Turning now to FIGS. 3A-3F, various example ATM 220 display screens for conducting an ATM cash reload of a user's prepaid card 100 are illustrated. FIG. 3A illustrates an example “Menu” screen 300 which the user 210 encounters upon authenticating to the ATM 220. The screen 300 will generally include a screen name 320. This screen 300 may include various options for the user to choose from. For instance, in this example, the user may choose to withdraw cash, load cash, perform a balance inquiry, set preferences, view additional options or cancel the transaction utilizing the interactive icons 330. The available area 340 may be utilized for specific communications to the user 210, such as, for instance, indicating an error message if one or more functions are not available.

FIG. 3B illustrates an example embodiment of the “Additional Options” screen 301. In this embodiment, the additional options include locating nearby ATM 220 locations in which the user 210 may reload his prepaid card 100. The user 210 may also have the option to return to the previous menu or cancel the transaction as illustrated.

FIG. 3C illustrates an example embodiment of the “Cash Load” screen 302. As illustrated, the ATM 220 may instruct the user 210 to load the cash in the cash pocket of the ATM 220. The screen 302 may include a graphic display 340 indicating how/where to load the cash into the ATM 220 as well as textual instructions 350. In a preferred embodiment, the user 210 loads the cash into the ATM 220 and the ATM 220 automatically counts the funds and displays the amount loaded (FIG. 3D). In other embodiments, the ATM 220 may or may not automatically count the loaded cash, but present the user 210 with a screen requesting the user 210 to manually input the amount that was/will be loaded into the ATM 220. The amount inputted by the user 210 may be subsequently verified.

FIG. 3D illustrates an example embodiment of the “Cash Load Results” screen 303. Here, the amount loaded into the ATM 220 is displayed. The user 210 may be presented with additional options such as load more cash, cancel, or continue.

In FIG. 3E, an example embodiment of a “Cash Load Acceptance” screen 304 is illustrated. The ATM 220 may inform the user 210 that the cash load has been accepted and give the user the option to load more cash or complete the transaction. The user 210 may then be presented a “Receipt” screen 305, an example of which is illustrated in FIG. 3F. The user may choose whether to receive a receipt upon completing the transaction.

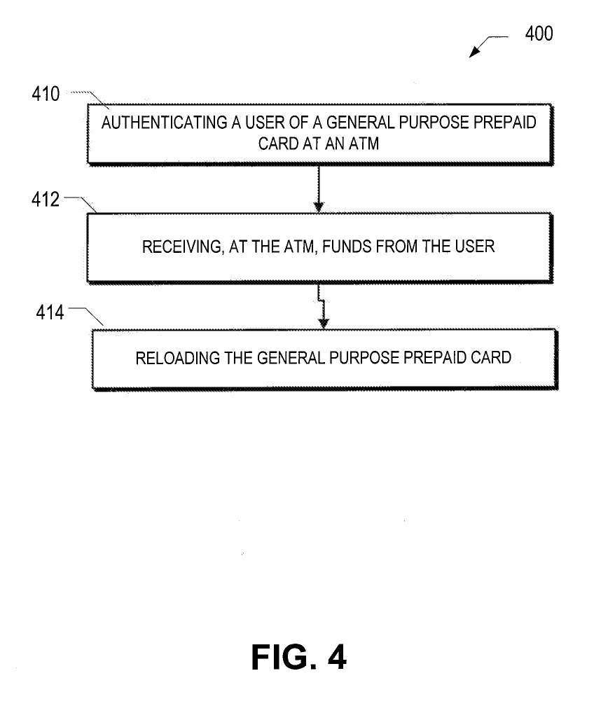

Referring now to FIG. 4, illustrated is a high level flow diagram of a method 400 for reloading a prepaid card 100 at an ATM 220. At block 410, a user 210 of a general purpose prepaid card 100 is authenticated at the ATM 220. The authentication may be by any means. For instance, the user 210 may present a physical prepaid card 100 to the ATM 220, some other user-identifying card, smart card, token (e.g., USB token, etc.), username, password, PIN, biometric information, and/or one or more other credentials that the user 210 presents to the ATM 220.

The method 400 advances to block 420 wherein the user 210 inputs funds for loading to the prepaid card 100 into the ATM 220. In a particular embodiment, the funds received from the user are cash-only funds. In other embodiments, the funds may include checks. Upon receiving the funds from the user 210, the ATM 220, may, for instance, interact with reloadable prepaid platform 240 to reload the general purpose funds to the prepaid card 100 less any fees, if any, as indicated at block 430.

In some embodiments, the general purpose prepaid card 100 may not be a physical card, but rather embodied in a mobile wallet of a user's mobile device. In such embodiments, the user may connect to the ATM 220 wirelessly if the ATM 220 is equipped with a wireless interface. Alternatively, the user may authenticate to the ATM 220 and the prepaid card 100 may be updated electronically after the user 210 has reloaded the prepaid card 100.

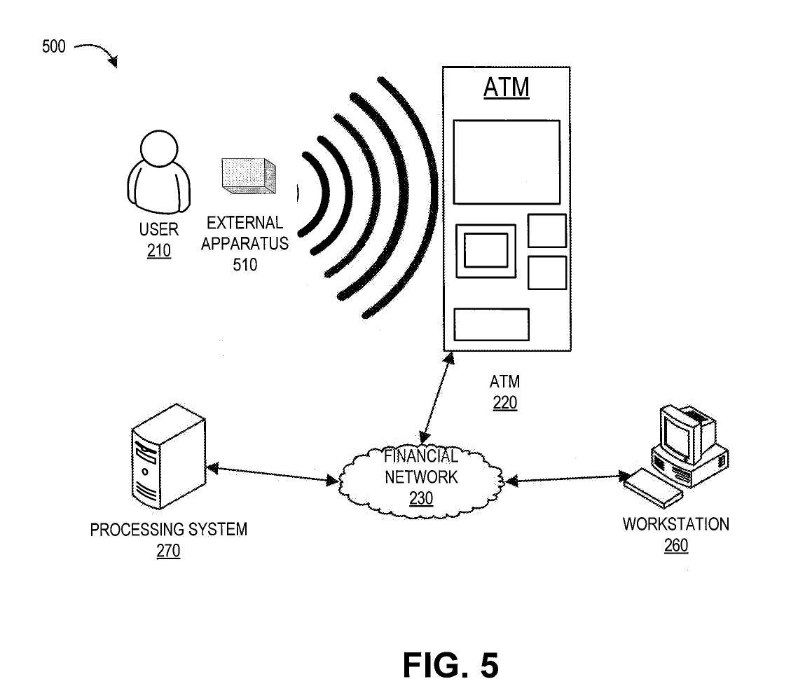

Referring to FIG. 5, a block diagram illustrating a contactless transaction environment 500 configured for initiating a contactless transaction via an external apparatus 510 is shown. As illustrated, the contactless transaction environment 500 may include an external apparatus 510 operated by a user 210 who may be a customer who wants to make an ATM 220 transaction. The contactless transaction environment 500 may also include a workstation 260 and a processing system 270 that are in electronic communication with the ATM 220 via the financial network 230, which may include connection via the Internet, an intranet or the like.

Referring now to FIG. 6, the ATM 220 includes a communication interface 610, a processor 620, a user interface 630, and a memory 640 having an ATM datastore 642 and an ATM application 644 stored therein. As shown, the processor 620 is operatively connected to the communication interface 610, the user interface 630, and the memory 640.

The communication interface 610 of the ATM may include a contactless interface 700 if the ATM 220 is equipped to interact wirelessly with a user's mobile device 900. In one embodiment, the contactless interface is an NFC interface. The contactless interface 700 is configured to contactlessly and/or wirelessly send and/or receive information over relatively short ranges (e.g., within four inches, within three feet, etc.). The contactless interface 700 may include a transmitter, receiver, smart card, key card, proximity card, Bluetooth® device, radio frequency identification (RFID) tag and/or reader, and/or the like. In some embodiments, the contactless interface 700 communicates information via radio, IR, and/or optical transmissions. Generally, the contactless interface 700 is configured to operate as a contactless transmitter and/or as a contactless receiver. The contactless interface 700 functions to enable transactions with users utilizing an external apparatus capable of contactless communication. Also, it will be understood that the contactless interface 700 may be embedded, built, carried, and/or otherwise supported in and/or on the ATM 220. In some embodiments, the contactless interface 700 is not supported in and/or on the ATM 220, but the contactless interface 700 is otherwise operatively connected to the ATM 220 (e.g., where the contactless interface 700 is a peripheral device plugged into the ATM 220, etc.). The contactless interface 700 of the ATM 200 is configured to contactlessly and/or wirelessly communicate information to and/or from an external apparatus 510.

The communication interface 610 may generally also include a modem, server, transceiver, and/or other device for communicating with other devices and systems on a network.

The user interface 630 of the ATM 220 may include a display (e.g., a liquid crystal display, a touchscreen display, and/or the like) which is operatively coupled to the processor 620. The user interface 630 may include any number of other devices allowing the ATM 220 to transmit/receive data to/from a user, such as a keypad, keyboard, touch-screen, touchpad, microphone, mouse, joystick, other pointer device, button, soft key, and/or other input device(s).

As further illustrated in FIG. 6, the memory 640 may include ATM applications 644. It will be understood that the ATM applications 644 can be executable to initiate, perform, complete, and/or facilitate one or more portions of any embodiment described and/or contemplated herein. Generally, the ATM application 644 is executable to receive transaction instructions from the user and perform typical ATM functions, as appreciated by those skilled in the art. In some embodiments of the invention, the ATM application 644 is configured to access content, such as data stored in memory 640, for example in the ATM datastore 642, or a database in communication with the ATM 220 and may transfer the content to the external apparatus 510 if the external apparatus 510 is configured for contactless communication. The content may include financial receipts, account-related documentation, reissued prepaid cards, new prepaid cards, etc.

Of course, the ATM 220 may require users to identify and/or authenticate themselves to the ATM 220 before the ATM 220 will initiate, perform, complete, and/or facilitate a transaction. For example, in some embodiments, the ATM 220 is configured (and/or the ATM application 644 is executable) to authenticate an ATM user 210 based at least partially on an ATM identification card, smart card, token (e.g., USB token, etc.), username, password, PIN, biometric information, and/or one or more other credentials that the user presents to the ATM 220. Additionally or alternatively, in some embodiments, the ATM 220 is configured to authenticate a user by using one-, two-, or multi-factor authentication. For example, in some embodiments, the ATM 220 requires two-factor authentication, such that the user must provide a valid general purpose prepaid card 100 and enter the correct PIN associated with the card 100 in order to authenticate the user 210 to the ATM 220. However, in some embodiments, the user 210 may access the ATM 220 and view or receive content that may be transferred to/from the ATM 220.

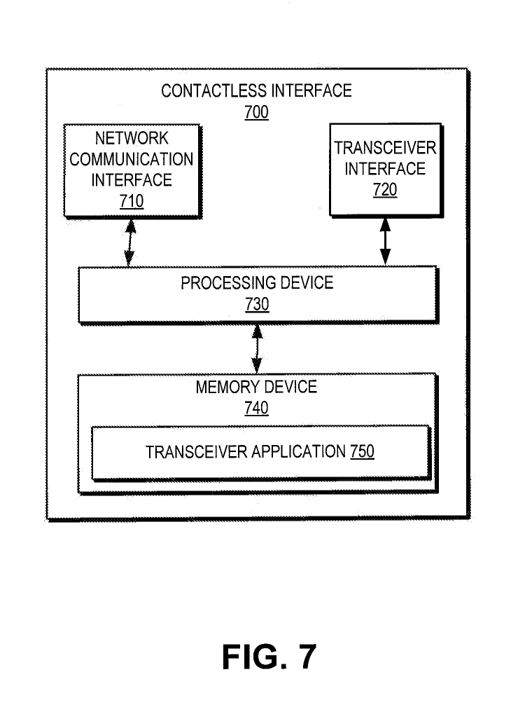

Referring now to FIG. 7, one embodiment of the contactless interface 700 is illustrated. The contactless interface 700 may include various features, such as a network communication interface 710, a processing device 730, a transceiver interface 720 (or just a receiver if only intended for one-way communication), and a memory device 740 that may include a transceiver application 750.

As used with respect to the contactless interface 700, a “communication interface” may generally include a modem, server, transceiver, and/or other device for communicating with other devices on a network. The network communication interface 710 may be a communication interface having one or more communication devices configured to communicate with one or more other devices in the contactless transaction environment 500, such as the external apparatus 510, the workstation 260, the processing system 270, other processing systems, data systems, etc.

In one embodiment, the transceiver interface 720 is a separate module that may generally include a transceiver, i.e., one or more antennas and/or other electronic circuitry, devices, and software, for receiving prepaid card data when the external apparatus 510 is held close to or tapped at the contactless interface 700 of the ATM 220. In some embodiments, the transceiver interface 720 is part of the network communication interface 710. Furthermore, the transceiver interface 720 may also be used as an interface to send content to the external apparatus 510 when the external apparatus 510 is held close to or tapped at the contactless interface 700.

An output device for the transceiver interface 720 may include a display that provides instructions regarding the steps for making a contactless transaction. In some embodiments where the ATM 220 requests the user's signature (if needed), the display may also serve as a touchpad input device to input the user's signature via a stylus. Other output devices may include one or more LEDs or an audio speaker, both which may indicate to the user that data has been successfully received from the external apparatus 510. A printer that can print paper receipts may also be incorporated into the ATM 220. However, in one embodiment, receipts are electronically transferred to the external apparatus 510. Other embodiments of the contactless interface 700 may carry other input and output devices, such as a mouse, keyboard, button, touchpad, touch screen, microphone, speaker, light, joystick, switch, or the like.

As used with respect to the contactless interface 700, a “processing device,” 730 may generally refer to a device or combination of devices having circuitry used for implementing the communication and/or logic functions of a particular system. For example, a processing device 730 may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 730 may be configured to use the network communication interface 710 and/or the transceiver interface 720 to transmit and/or receive data and/or commands to and/or from the other devices that are communicating in the contactless payment environment 500.

As used with respect to the contactless interface 700, a “memory device” 740 may generally refer to a device or combination of devices that store one or more forms of computer-readable media for storing data and/or computer-executable program code/instructions. For example, in one embodiment, the memory device 740 may include any computer memory that provides an actual or virtual space to temporarily or permanently store data and/or commands provided to the processing device 730 when it carries out its functions described herein. In one embodiment, the memory device 740 stores a transceiver application 750. The transceiver application 750 may work in conjunction with the previously described transceiver interface 720 to receive electronic card 100 data when the external apparatus 510 is held close to or tapped at the contactless interface 700. In some particular embodiments, the transceiver application 750 may also be configured to send data to the external apparatus 510 when the external apparatus 510 is held close to or tapped at the ATM 220. The transceiver application 750 may also potentially provide a power source to the external apparatus, in the event the primary power source is depleted (or a completely passive chip or module is utilized in the external apparatus 510 to yield contactless functionality), in order to power the external apparatus 510 to initiate the transaction.

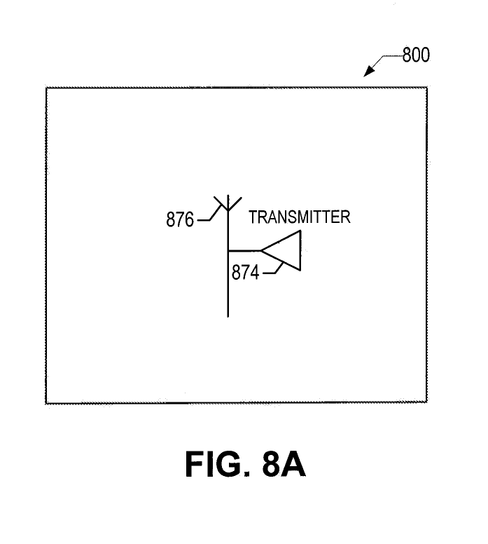

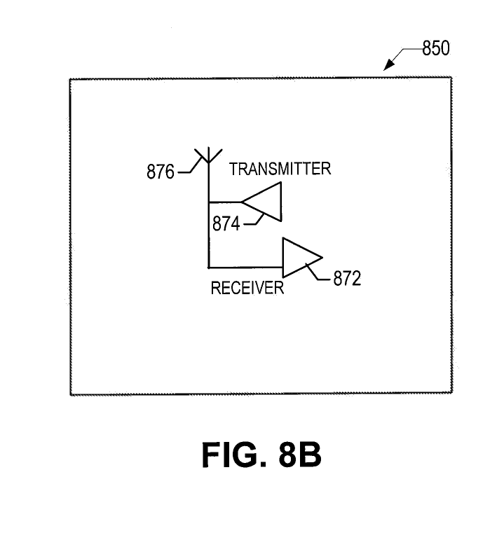

Referring to FIGS. 8A and 8B, an external apparatus 800 and 850 is illustrated. Generally speaking, the external apparatus 800/850 may be anything that includes a chip or module capable of wireless transmission of the required data for contactless transactions. However, the most common external apparatus 800/850 is a physical general purpose prepaid card 100. Also “stickers” have emerged somewhat recently. Such stickers include the chip or module and may be placed on anything convenient. Generally, such stickers are to be placed on an otherwise non-contactless functioning physical prepaid card 100 or possibly a mobile device 900 such as a mobile phone. FIGS. 8A and 8B are intended to encompass physical prepaid cards and stickers. Of note, the size of the prepaid card 100 is not limited to the size of conventional credit/debit cards. Indeed, the prepaid card 100 may be substantially smaller (such as a keychain card) than conventional cards. Further, the prepaid card 100 may not be a “card” at all, but rather a fob or some other type of token.

FIG. 8A illustrates a prepaid card or sticker 800 that is configured for one-way transmission. The card/sticker 800 illustrated in FIG. 8A does not include a data receiving means. As such, the card/sticker is only capable of one-way transmission of data from the card/sticker to the ATM 220. Generally speaking, such card/sticker functionality is by way of a passive routine, i.e., the chip or module that transmits the information does not include a separate source of power. Rather, the ATM 220 (and specifically, the contactless interface 700), or some other external power source, may provide the power to initiate the transmission by, for instance, producing an external electromagnetic field that provides the power to allow the card/sticker transmitting antenna 876 to initiate a transmission from the transmitter 874, via radio frequency electromagnetic waves. Of note, FIG. 8A illustrates an embodiment that is generally a passive routine. However, if desired, a dedicated power source could be provided in order to utilize an active routine, as will be appreciated by those skilled in the art.

FIG. 8B illustrates a card/sticker 850 that is configured for two-way transmission. The card/sticker 850 illustrated in FIG. 8B includes a transmitter 874 and a receiver 872 for transmitting and receiving data respectively. Generally, speaking, two-way communicating device functionality is achieved by an active routine where a separate power source (not illustrated) is also included. However, if desired, a two-way communicating card/sticker could be configured to utilize a passive routine.

Two-way communication cards/stickers, i.e. “smart” cards/stickers, enable information to be transferred in real-time between the card/sticker and other sources (including ATM 220) without the use of a carrier network or Wi-Fi access. Such “smart” cards/stickers are beneficial as they offer a plurality of desirable options, such as the ability to remotely deactivate lost or stolen cards/stickers.

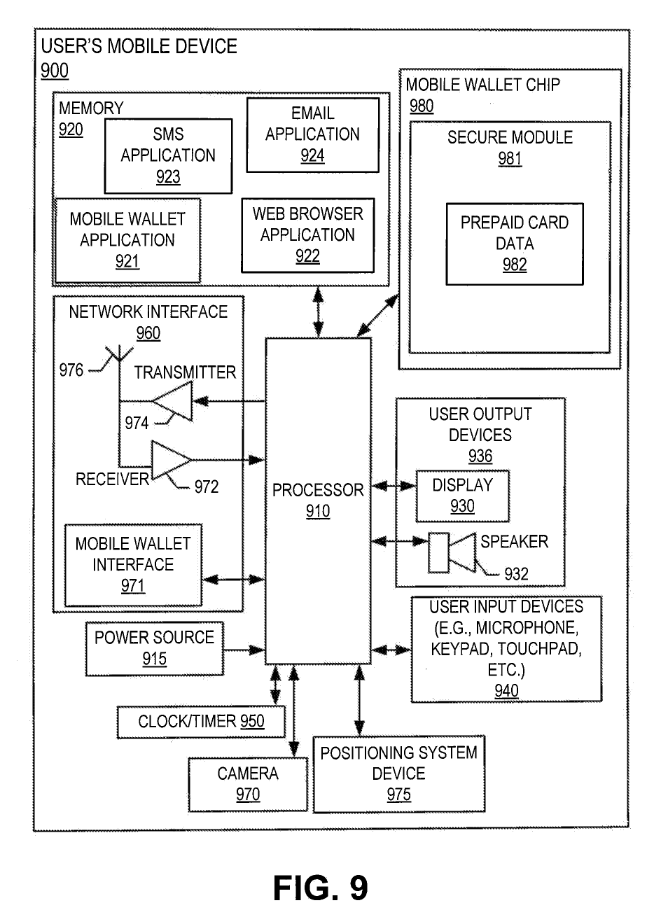

Turning now to FIG. 9, illustrated is an embodiment of a mobile device 900 that may be configured to make a contactless transaction at the ATM 220. A “mobile device” 900 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The mobile device 900 may generally include a processor 910 communicably coupled to such devices as a memory 920, user output devices 936, user input devices 940, a network interface 960, a power source 915, a clock or other timer 950, a camera 970, a positioning system device 975, one or more mobile wallet chips/memory 980, etc. The processor 910, and other processors described herein, may generally include circuitry for implementing communication and/or logic functions of the mobile device 900. For example, the processor 910 may include a digital signal processor device, a microprocessor device, and various analog to digital converters, digital to analog converters, and/or other support circuits. Control and signal processing functions of the mobile device 900 may be allocated between these devices according to their respective capabilities. The processor 910 thus may also include the functionality to encode and interleave messages and data prior to modulation and transmission. The processor 910 may additionally include an internal data modem. Further, the processor 910 may include functionality to operate one or more software programs, which may be stored in the memory 920. For example, the processor 910 may be capable of operating a connectivity program, such as a web browser application 922. The web browser application 922 may then allow the mobile device 900 to transmit and receive web content, such as, for example, location-based content and/or other web page content, according to a Wireless Application Protocol (WAP), Hypertext Transfer Protocol (HTTP), and/or the like.

The processor 910 may also be capable of operating a client application, such as a mobile wallet application 921. The mobile wallet application 921 may be downloaded from a server and stored in the memory 920 of the mobile device 900. Alternatively, the mobile wallet application 921 may be pre-installed and stored in a memory in the mobile wallet chip 980. In such an embodiment, the user may not need to download the mobile wallet application 921 from a server. In some embodiments, the mobile wallet application 921 may have a graphical user interface (GUI) that allows the user to perform various transactional processes. The GUI may also allow the user to set certain payment preferences or mobile wallet preferences.

The mobile wallet chip 980 includes a secure module 981 that may contain the prepaid card data 982. The mobile wallet chip/memory 980 may be an integrated circuit, a microprocessor, a system-on-a-chip, a microcontroller, or the like. In one embodiment, the mobile wallet chip/memory 980 provides Near Field Communication (NFC) capabilities to the device 900.

Of note, while FIG. 9 illustrates the mobile wallet chip 980 as a separate and distinct element within the mobile device 900, it will be apparent to those skilled in the art that the mobile wallet chip 980 functionality may be incorporated within other elements in the mobile device 900 or provided as a sticker affixed to the mobile device 900 as discussed above. For instance, the functionality of the mobile wallet chip 980 may be incorporated within the mobile device memory 920. In a particular embodiment, the functionality of the mobile wallet chip 980 is incorporated in an element within the mobile device 900 that provides NFC capabilities to the mobile device 900. However, it is not necessary for the mobile wallet chip 980 to provide the NFC capabilities to the mobile device 900. The mobile device 900 may include a NFC providing element (and/or other wireless communication systems) (not shown) separate from the mobile wallet chip 980.

The secure module 981 may be a memory device within the mobile wallet chip 980. The secure module 981 may comprise prepaid card data 982 associated with one or more prepaid cards 100. The prepaid card data 982 may be data typical of standard card-type payment vehicles. For instance, prepaid card data 982 that is stored in the secure module 981 may include the prepaid card type, the prepaid card number, the name associated with the prepaid card 100, the expiration date of the prepaid card 100, a security code associated with the prepaid card 100, etc.

In the embodiment depicted in FIG. 9, since the secure module 981 is stored in a memory in the mobile wallet chip 980 and not in a memory 920 in the mobile device 900, the user may be able to transfer the mobile wallet chip 980, if the mobile wallet chip 980 is not irreversibly integrated into the mobile device 900, to another mobile device and the user may consequently have access to the prepaid card 100 in the mobile wallet chip 980 on a different mobile device 900. Alternatively, the secure module 981 could be stored in a secured sector of memory 920 or other data storage of the mobile device 900 and be transferred to a new mobile device 900. Furthermore, the mobile wallet application 900 and/or data within the secure modules may be additionally stored on an external apparatus or network to provide the user with the capability to readily transfer their mobile wallet system from one mobile device 900 to another or to restore their mobile wallet system to their device 900, if needed.

The processor 910 may be configured to use the network interface 960 to communicate with one or more other devices on the financial network 230. In this regard, the network interface 960 may include an antenna 976 operatively coupled to a transmitter 974 and a receiver 972 (together a “transceiver”). The processor 910 may be configured to provide signals to and receive signals from the transmitter 974 and receiver 972, respectively. These signals may include radio frequency signals emanating from the mobile device's transmitter 974 when the mobile device is tapped at or held or waved in close proximity to the ATM 220. These signals may also include radio frequency signals received at the mobile device's receiver 972 when the mobile device is tapped at or held or waved in close proximity to the contactless apparatus 510. In one embodiment, these radio frequency signals may be transmitted and received in the radio frequency band, such as 13.56 MHz which is generally the frequency for NFC. In one embodiment, the ISO/IEC 14443 standard may define the protocol associated with the data carried by these radio frequency signals. In one embodiment, the transmitter 974 and receiver 972 at the mobile device may transmit and receive radio frequency signals, respectively, from a payment terminal within a distance of up to approximately 25 cm, and preferably from 0-20 cm, such as from 0-15 cm, and 0-10 cm.

As indicated earlier, the processor 910 may be configured to provide signals to and receive signals from the transmitter 974 and receiver 972, respectively. The signals may also include signaling information in accordance with the air interface standard of the applicable cellular system of the wireless telephone network that may be part of the financial network 230. In this regard, the mobile device 900 may be configured to operate with one or more air interface standards, communication protocols, modulation types, and access types. By way of illustration, the mobile device 900 may be configured to operate in accordance with any of a number of first, second, third, and/or fourth-generation communication protocols and/or the like. For example, the mobile device 900 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 900 may also be configured to operate in accordance with non-cellular communication mechanisms, such as via a wireless local area network (WLAN) or other communication/data networks.

The network interface 960 may also include a mobile wallet interface 971 in order to allow a user 210 to execute some or all of the above-described processes with respect to the mobile wallet application 921 and the secure module 981 of the mobile wallet chip 980. The mobile wallet interface 971 may have access to the hardware, e.g., the transceiver, and software previously described with respect to the network interface 960.

The mobile device 900 may comprise a transceiver that works in conjunction with the secure module 981 of the mobile device 900. In one embodiment, the antenna and other hardware or software that transmit prepaid card data from the secure module 981 of the mobile device 900 may be integrated into the secure module 981.

As described above, the mobile device 900 may have a user interface that includes user output devices 936 and/or user input devices 940. The user output devices 936 may include a display 930 (e.g., a liquid crystal display (LCD) or the like) and a speaker 932 or other audio device, which are operatively coupled to the processor 910. The user input devices 940, which may allow the mobile device 900 to receive data from a user 210, may include any of a number of devices allowing the mobile device 900 to receive data from a user 210, such as a keypad, keyboard, touch-screen, touchpad, microphone, mouse, joystick, other pointer device, button, soft key, and/or other input device(s).

The mobile device 900 may further include a power source 915. Generally, the power source 915 is a device that supplies electrical energy to an electrical load. In one embodiment, power source 915 may convert a form of energy such as solar energy, chemical energy, mechanical energy, etc. to electrical energy. Generally, the power source 915 in a mobile device 900 may be a battery, such as a lithium battery, a nickel-metal hydride battery, or the like, that is used for powering various circuits, e.g., the transceiver circuit, and other devices that are used to operate the mobile device 900. Alternatively, the power source 915 may be a power adapter that can connect a power supply from a power outlet to the mobile device 900. In such embodiments, a power adapter may be classified as a power source “in” the mobile device.

The mobile device 900 may also include a memory 920 operatively coupled to the processor 910. As used herein, memory may include any computer readable medium configured to store data, code, or other information. The memory 920 may include volatile memory, such as volatile Random Access Memory (RAM) including a cache area for the temporary storage of data. The memory 920 may also include non-volatile memory, which can be embedded and/or may be removable. The non-volatile memory may additionally or alternatively include an electrically erasable programmable read-only memory (EEPROM), flash memory or the like.

The memory 920 may store any of a number of applications or programs which comprise computer-executable instructions/code executed by the processor 910 to implement the functions of the mobile device 900 described herein. For example, the memory 920 may include such applications as a web browser application 922 and a mobile wallet application 921. The mobile wallet application 921 may be capable of performing one or more functions described above. These applications may also typically provide a graphical user interface (GUI) on the display 930. For instance, as described previously, the GUI for the mobile wallet application 921 may allow the user 210 to enter input to select a prepaid card 100 or to transmit to a contactless apparatus 510 or otherwise transact with the contactless apparatus 510.

The memory 920 may also store any of a number of pieces of information, and data, used by the mobile device 900 and the applications and devices that make up the mobile device 900 or are in communication with the mobile device 900 to implement the functions of the mobile device 900 and/or the other systems described herein. For example, the memory 920 may include such data as user authentication information to gain access to the mobile wallet application 921, user authentication information for each payment vehicle that is stored by or accessible via the mobile wallet application 921 including, for instance, prepaid card data 982, user authentication information to access the secure module 981 of the mobile wallet chip 980, etc. In other embodiments, this authentication information may be stored in a memory of the mobile wallet chip 980.

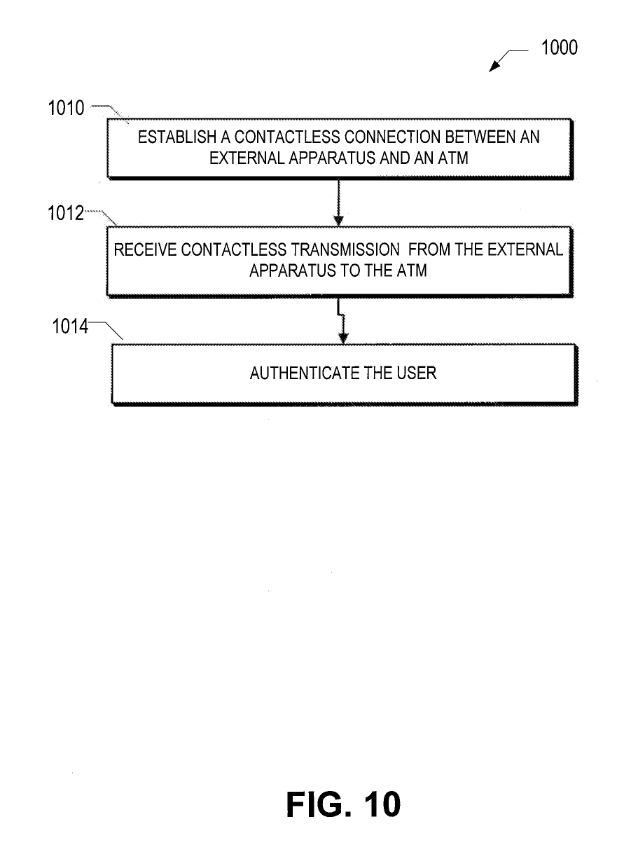

Referring now to FIG. 10, illustrated is a high level flow diagram of a method 1000 for receiving a contactless transmission from an external apparatus 510. At block 1010, a contactless connection between the external apparatus 510 and an ATM 220 is established. In one embodiment, the external apparatus 510 is a prepaid card 100. In particular embodiments the contactless connection is an NFC connection. Upon establishing the contactless connection, the user may be required to provide authentication.

After the contactless connection is established, the method moves to block 1012 where the contactless transmission is received from the external apparatus 510 to the ATM 220. As noted above, typical content to be transferred from the external apparatus 510 includes data identifying the prepaid card 100 account associated with the external apparatus 510.

Finally, moving to block 1014, the ATM 220 authenticates the user 210 (if required). This may be accomplished by any of the means noted above, but generally will include entering a Personal Identification Number (PIN) after the ATM 220 has received the transmitted data.

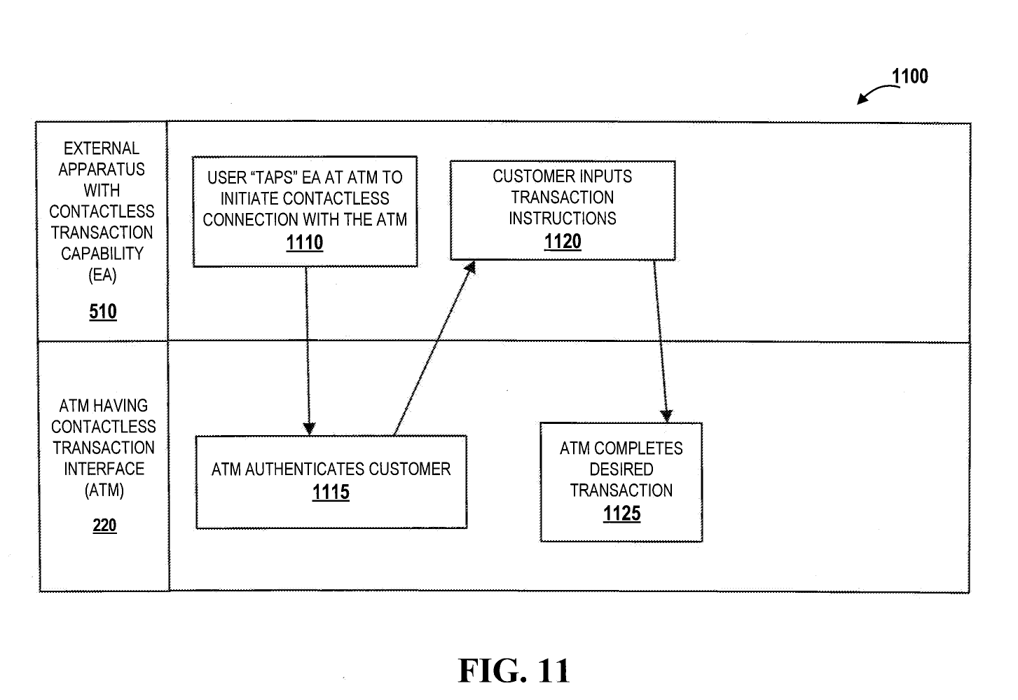

FIG. 11 illustrates a mixed block and flow diagram of a system 1100 for engaging in a contactless transaction between an ATM 220 and an external apparatus 510, in accordance with an embodiment of the present invention. It will be understood that the system 1100 illustrated is an example embodiment. As shown, the system 1100 includes an external apparatus 510 having a contactless transaction interface and an ATM 220 having a contactless transaction interface.

In this example embodiment, the external apparatus 510 is operatively connected to the ATM 220 via the contactless interface of the ATM 220. In addition, the external apparatus and/or the ATM 220 may be operatively connected to one or more networks, servers, etc. The ATM 220 is maintained by the financial institution and the external device is preferably, but not necessarily, maintained by a customer of the financial institution.

As represented by block 1110, the customer taps the external apparatus 510 at the ATM 220 to initiate a contactless connection with the ATM. For example, the customer may “tap” the external apparatus 510 by positioning the external apparatus 510 within close proximity of the contactless interface of the ATM 220, such that a connection is established. In one embodiment, the contactless connection is an NFC connection.

Block 1115 represents the ATM 220 authenticating the customer (if required). Authentication may be by any typical means as understood by those skilled in the art, but generally requires the customer to enter a PIN associated with the account the customer wishes to authenticate himself to the ATM 220. Of note, while FIG. 11 illustrates the contactless connection being established prior to ATM 220 authentication, the customer may first authenticate himself prior to the contactless connection being established. For instance, the customer may input authentication information on his external apparatus 510 and transfer such data to the ATM 220 upon establishing the contactless connection. Alternatively, the customer may authenticate, for instance, by swiping an identification card associated with the account and entering a PIN at the ATM 220 prior to establishing the contactless connection. Furthermore, ATM authentication may not be required for certain transactions. For instance, ATM authentication may not be necessary for the cash load process.

At block 1120, the customer inputs instructions to the ATM 220 to execute the desired transaction such as loading cash to the prepaid card 100. Of course, the desired transaction may include any type of ATM transaction such as, for example, withdrawing funds, balance checks, etc. Block 1125 represents the ATM 220 completing the customer's desired transaction.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein above with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for reloading a general purpose prepaid card at an automated teller machine (ATM) comprising:
authenticating a user of the general purpose prepaid card at the ATM, wherein the prepaid card is associated with a financial institution;
receiving, at the ATM, funds from the user; and
reloading the general purpose prepaid card.

2. The method of claim 1, wherein the ATM is operated by a financial institution associated with the prepaid card.

3. The method of claim 1, further comprising communicating with a reloadable prepaid platform.

4. The method of claim 3, wherein the reloadable prepaid platform is administrated by a third-party.

5. The method of claim 4, wherein the third-party is additionally associated with one or more financial institutions other than the financial institution associated with the prepaid card.

6. The method of claim 5, wherein the prepaid card may be reloaded at an ATM of at least one of the one or more financial institutions other than the financial institution associated with the prepaid card.

7. The method of claim 1, wherein the funds received are cash only.

8. The method of claim 1, wherein the funds received comprise checks.

9. The method of claim 1, wherein the ATM is configured to reload the prepaid card irrespective of any other association including financial accounts between the user and the financial institution.

10. The method of claim 1, wherein the reloadable prepaid card is a consumer reloadable prepaid card.

11. The method of claim 1, wherein the prepaid card is a magnetic stripe card.

12. The method of claim 1, wherein the funds received at the ATM are immediately reloaded to the prepaid card.

13. The method of claim 1, wherein the ATM comprises a contactless interface.

14. The method of claim 1, wherein the prepaid card is a physical card and is configured for wireless communication.

15. The method of claim 1, wherein the prepaid card is embodied in a mobile wallet of a mobile device of the user.

16. A system for reloading a general purpose prepaid card at an automated teller machine (ATM) comprising:
an ATM, wherein the ATM comprises a processing device configured for:
authenticating a user of the general purpose prepaid card at the ATM, wherein the prepaid card is associated with a financial institution;
receiving, at the ATM, funds from the user; and
reloading the general purpose prepaid card;
a financial network in communication with the ATM; and
a reloadable prepaid platform in communication with the financial network.

17. The system of claim 16, wherein the ATM is operated by a financial institution associated with the prepaid card.

18. The system of claim 16, wherein the reloadable prepaid platform is administrated by a third-party.

19. The system of claim 18, wherein the third-party is additionally associated with one or more financial institutions other than the financial institution associated with the prepaid card.

20. The system of claim 19, further comprising a second ATM of one of the one or more financial institutions other than the financial institution associated with the prepaid card, wherein the prepaid card may additionally be reloaded at the second ATM.

21. The system of claim 16, wherein the funds received are cash only.

22. The system of claim 16, wherein the funds received comprise checks.

23. The system of claim 16, wherein the processing device is configured to reload the prepaid card irrespective of any other association including financial accounts between the user and the financial institution.

24. The system of claim 16, wherein the reloadable prepaid card is a consumer reloadable prepaid card.

25. The system of claim 16, wherein the ATM comprises a contactless interface.

26. The system of claim 16, wherein the prepaid card is a physical card and is configured for wireless communication.

27. The system of claim 16, wherein the prepaid card is embodied in a mobile wallet of a mobile device of the user.

28. A computer program product for reloading a general purpose prepaid card at an automated teller machine (ATM), the computer program product comprising a non-transitory computer readable medium comprising computer-readable instructions, the instructions comprising:
instructions for authenticating a user of the general purpose prepaid card at the ATM, wherein the prepaid card is associated with a financial institution;
instructions for receiving, at the ATM, funds from the user; and
instructions for reloading the general purpose prepaid card.

29. The computer program product of claim 28, wherein the ATM is operated by a financial institution associated with the prepaid card.

30. The computer program product of claim 28, wherein the instructions further comprise instructions for communicating with a reloadable prepaid platform.

31. The computer program product of claim 30, wherein the reloadable prepaid platform is administrated by a third-party.

32. The computer program product of claim 31, wherein the third-party is additionally associated with one or more financial institutions other than the financial institution associated with the prepaid card.

33. The computer program product of claim 32, wherein the instructions further comprise instructions for reloading the prepaid card at an ATM of at least one of the one or more financial institutions other than the financial institution associated with the prepaid card.

34. The computer program product of claim 28, wherein the funds received are cash only.

35. The computer program product of claim 28, wherein the funds received comprise checks.

36. The computer program product of claim 28, wherein the instructions comprise instructions for reloading the prepaid card irrespective of any other association including financial accounts between the user and the financial institution.

37. The computer program product of claim 28, wherein the reloadable prepaid card is a consumer reloadable prepaid card.

38. The computer program product of claim 28, wherein the instructions comprise instructions for immediately reloading the prepaid card upon receipt of the funds at the ATM.

39. The computer program product of claim 28, wherein the ATM comprises a contactless interface.

40. The computer program product of claim 28, wherein the prepaid card is a physical card and is configured for wireless communication.

41. The computer program product of claim 28, wherein the prepaid card is embodied in a mobile wallet of a mobile device of the user.
